(19) United States
(12) Patent Application Publication
(10) Pub. No.: US 2008/0000702 A1
(43) Pub. Date: Jan. 3, 2008

(54) Device for torque distribution

(75) Inventors: Florian Oesterreicher, Muenchen (DE); Torsten Franke, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/819,318

(22) Filed: Jun. 26, 2007

(30) Foreign Application Priority Data
Jun. 30, 2006 (DE) 102006030197.8

(51) Int. Cl. B60K 1/00

(52) U.S. Cl. 180/65.3

(57) ABSTRACT

A device for torque distribution between two rotatably mounted shafts, in particular between two rotating shafts of a drivetrain of a motor vehicle. The device includes an electrical machine having a rotor and a stator, the rotor being coupled support-free to one of the two shafts and the stator being coupled support-free to the other of the two shafts. Furthermore, the device includes a control unit coupled to the electrical machine for the purpose of control signal transmission, the electrical machine being drivable as a function of the control signals of the control unit in such a way that targeted transmission of torque between the two shafts is possible.

### CROSS REFERENCE TO RELATED APPLICATIONS

This application claims priority under 35 U.S.C. § 119 to German Patent Application No. 102006030197.8 filed Jun. 30, 2006, the entire disclosure of which is herein expressly incorporated by reference.

### BACKGROUND AND SUMMARY OF THE INVENTION

The present invention relates to a device for torque distribution between two rotatably mounted shafts, in particular a device for torque distribution between two rotating and/or rotatably mounted, directly or indirectly driven shafts (and/or axles, shaft sections, or axle sections) in the drivetrain of a motor vehicle.

Greatly varying measures are already known for changing the torque distribution between axle sections of a directly driven or a nondirectly driven (and/or indirectly driven) vehicle axle. For example, for automatic chassis and suspension control systems such as DSC (BMW name for a chassis and suspension control system for dynamic stability control of the motor vehicle; operating instructions 7 series BMW, model year 2006, online version for item number 01 40 0 012 268—January 2006), in critical driving situations, the drivability of the vehicle is ensured by corresponding targeted braking interventions (and thus a change of the torque distribution between the axle sections of the vehicle axis) via automatic braking interventions which are performed by the DSC control system on the basis of monitored drivability-relevant operating parameters. Systems of this type have already proven themselves in many ways. Systems of this type have the disadvantage of dissipation of drive power caused by the automatic braking interventions.

Furthermore, performing a distribution of the torque in a driven vehicle axle via differential gears is known. In systems of this type, distribution of the torque is only possible in narrow limits. Furthermore, these systems are not implemented as controllable.

Finally, vehicles having electrical wheel hub motors are known, in which it is possible to distribute torque between sections of a vehicle axle by targeted activation of the individual wheel hub motors. The systems are costly to implement, require a large amount of additional installation space, and cause significant additional vehicle weight.

A drive axle having variable torque distribution is known from International patent document WO 2004/022373 A1. This drive axle includes a drivable middle shaft and a driveshaft coupled to each of the drive wheels, a superposition gear, which is drivable via an electrical machine, being situated between the driveshafts and the middle shaft in each case.

A device for distributing the drive torque to the left/right wheel of a motor vehicle is described in European patent document EP 0 575 152 B1. This device includes a controllable transmission unit in the drive axle between the left and right drive wheels and a control unit for activating the transmission unit as a function of information describing the driving condition of the vehicle.

An object of the present invention is to provide an alternative device for torque distribution, which allows targeted distribution of torque between two rotatably mounted and directly or indirectly driven shafts. In particular, the device requires a significantly smaller installation space and has a significantly lower weight than previously known systems. Furthermore, the suggested device undergoes less wear and can be implemented more cost-effectively than typical systems.

This and other objects and advantages are achieved according to the present invention by a device which includes two rotatably mounted shafts (and/or axles, shaft sections, or axle sections), which are operationally linked to one another, an electrical machine, a control unit which activates the electrical machine, and a power supply unit which supplies the electrical machine with energy. According to the present invention, the so-called stator of the electrical machine is coupled and/or operationally linked support-free (i.e., without support on a fixed and/or non-rotating part, such as the chassis or the vehicle body) to one shaft and the so-called rotor of the electrical machine is coupled and/or operationally linked support-free to the other shaft. The operational linkage of stator and rotor of the electrical machine in each case to one of the rotatably mounted shafts is such that both parts (stator and rotor) are driven (rotated) by the shafts coupled thereto—a typical, fixed machine part (normally formed by the stator) is not provided. An additional torque (electrical machine torque) is generated between the two shafts coupled to the stator and rotor by the activation of the electrical machine via the control unit. Depending on the rotational direction of the electrical machine, one shaft is braked and the other shaft is correspondingly accelerated by this additional torque (generation of an additional relative rotational velocity of one shaft to the other shaft).

In different embodiments of the present invention, different shafts and/or axles or shaft sections and/or axle sections may thus be coupled to one another via an electrical machine and controlled or regulated torque equalization may be caused between them. Additional exemplary embodiments of possible types of couplings are specified below.

Primarily, one may differentiate between two developments of the system according to the present invention.

In a first development of the system according to the present invention, an electrical machine for the purpose of torque transmission (and/or targeted torque distribution) is situated parallel to a transmission unit connecting the two shafts. The stator of the electrical machine may be connected via a first gearwheel connection to one shaft and the rotor of the electrical machine may be connected via a second gearwheel connection (or a belt or chain connection of the like) to the other shaft, the cited transmission unit (e.g., a typical differential gear or a transfer case in an all-wheel vehicle) being situated between first and second gearwheel connections.

In a first possible embodiment of this development, the rotatably mounted shafts are formed by the axle sections of a driven vehicle axle (FIG. 1). In a second exemplary embodiment of this development, one of the shafts is implemented as an axle section of a rotatably mounted vehicle axle, while the second shaft is formed by the driveshaft (transmission output shaft) driving a differential gear (FIG. 2). Finally, it is conceivable that both shafts are components of a driveshaft of an all-wheel vehicle connecting the front axle to the rear axle, the driveshaft to the front axle originating from the transfer case in the drivetrain being coupled to the one drive part (stator/rotor) of the electrical machine, while the driveshaft to the rear axle originating from the transfer case in the drivetrain is coupled to the other drive part (rotor/stator) of the electrical machine (FIG. 3).

In a second development of the system according to the present invention, an electrical machine is situated directly between two rotatably mounted shafts (without the shafts being coupled to one another via a transmission unit). The stator of the electrical machine may be situated directly on one shaft and the rotor of the electrical machine may be situated directly on the other shaft in such a way that both shafts (shaft sections) are coupled in regard to force via the electrical machine. This embodiment is particularly suitable for non-driven axles of a vehicle (e.g., the front axle of a motor vehicle having rear wheel drive or vice versa).

However, it is also conceivable to incorporate the electrical machine in a connection shaft, driven by the drive unit of the motor vehicle, between front wheel axle and rear wheel axle of a motor vehicle having front wheel or rear wheel drive (not shown) in such a way that this connection shaft is divided into two shafts (shaft sections), the first shaft section carrying one drive part of the electrical machine and the other shaft section carrying the other drive part of the electrical machine (and the two shaft sections thus being coupled to one another in regard to force).

Various exemplary embodiments of the present invention are illustrated in the drawing and described in greater detail in the following.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the device according to the present invention for torque distribution in the drivetrain of a motor vehicle in a first possible embodiment,

FIG. 2 shows the device according to the present invention for torque distribution in the drivetrain of a motor vehicle in a second possible embodiment,

FIG. 3 shows the device according to the present invention for torque distribution in the drivetrain of a motor vehicle in a third possible embodiment, and

FIG. 4 shows the device according to the present invention for torque distribution in an indirectly driven vehicle axle of a motor vehicle (fourth possible embodiment).

### DETAILED DESCRIPTION OF THE DRAWINGS

In the following, the rotatably mounted shafts which are coupled to one another via an electrical machine in the meaning of the present invention are individually identified on one hand as a function of their function. On the other hand, the coupled shafts are additionally provided with the general identification W. This is to improve the overview and to clarify the generally valid principle of the present invention.

The device according to the present invention for torque distribution between two rotatably mounted and directly or indirectly driven shafts W is advantageously a component of a drivetrain of a motor vehicle or a component of an indirectly driven vehicle shaft, such as a non-driven vehicle axle (e.g., front axle of a rear wheel drive vehicle). The device includes a first and a second rotatably mounted and directly or indirectly driven shaft W, which are connected to one another via coupling means in such a way that shaft speeds and/or shaft torques deviating from one another are possible. Furthermore, the device includes an electrical machine EM having a rotor R and a stator S, as well as a power supply unit supplying the electrical machine. According to the present invention, the rotor R and the stator S are each coupled support-free (i.e., without support on a fixed part, such as the motor vehicle body and/or the suspension) to one of the two shafts W. In this way, the rotational movement of the particular shaft W is at least partially transmitted to the stator S or the rotor R (and/or the rotational movement of the particular shaft W is at least partially also performed and/or transmitted to stator S or rotor R—i.e., possibly at another speed). Furthermore, a control unit SE coupled to the electrical machine EM for the purpose of control signal transmission is provided, via which the electrical machine EM is drivable as a function of the control signals of the control unit SE in such a way that an additional torque is impressed by the electrical machine EM between the two shafts W (and/or onto the two shafts), and thus targeted transmission of torque between the two shafts W is possible.

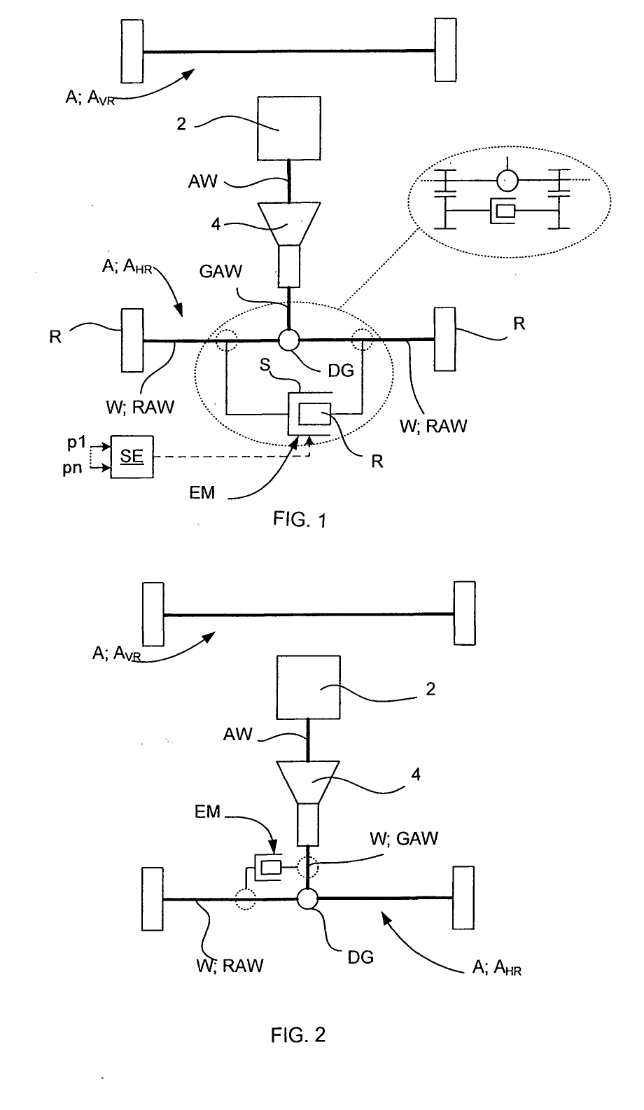

FIG. 1 shows a schematic illustration of the drivetrain of a motor vehicle, including a drive machine 2 (e.g., internal combustion engine or electric motor or the like) to generate a drive torque, a transmission unit 4 coupled thereto via a motor driveshaft AW, which drives a differential gear DG via a transmission output shaft GAW, as well as two wheel driveshafts RAW (W) (as a component of the driven vehicle axle A, here: rear axle A_{HR}), which are driven by the output of the differential gear DG and thus transmit torque to the drive wheels R. According to this first embodiment, one wheel driveshaft RAW forms a first rotatably mounted and (directly) driven shaft W and the other wheel driveshaft RAW forms a second rotatably mounted and (directly) driven shaft W, the stator S of the electrical machine EM being operationally linked to one wheel driveshaft RAW (W) and the rotor R of the electrical machine EM being operationally linked to the other wheel driveshaft RAW (W). The operational link and/or coupling between rotor R and wheel driveshaft RAW (W) and/or between stator S and other wheel driveshaft RAW (W) is produced, for example, via a fixed transmission stage (gearwheel pair). The detailed portion of FIG. 1 shows the gearwheel coupling between electrical machine EM and wheel driveshaft RAW (W). The electrical machine EM is activated via a control unit SE in such a way that an additional torque is impressed by the electrical machine EM between the two shafts W, and thus a targeted transmission of torque is made possible between the two shafts. The power supply unit supplying the electrical machine EM is not explicitly illustrated here, but will be described in greater detail at another point in different embodiments. For a better overview, the control unit SE is not illustrated and explained again in following FIGS. 2 through 4.

In the embodiment shown in FIG. 2, the electrical machine EM is situated between the transmission output shaft GAW (W) and a wheel driveshaft RAW (W). For example, the stator S of the electrical machine EM is coupled to one of the two wheel driveshafts RAW (W) (wheel driveshaft of the front axle (in the event of front wheel drive) or wheel driveshaft of the rear axle (in the event of rear wheel drive)), while the rotor R of the electrical machine EM is coupled to the shaft W (transmission output shaft GAW) of the transmission unit 4, which drives the differential gear DG.

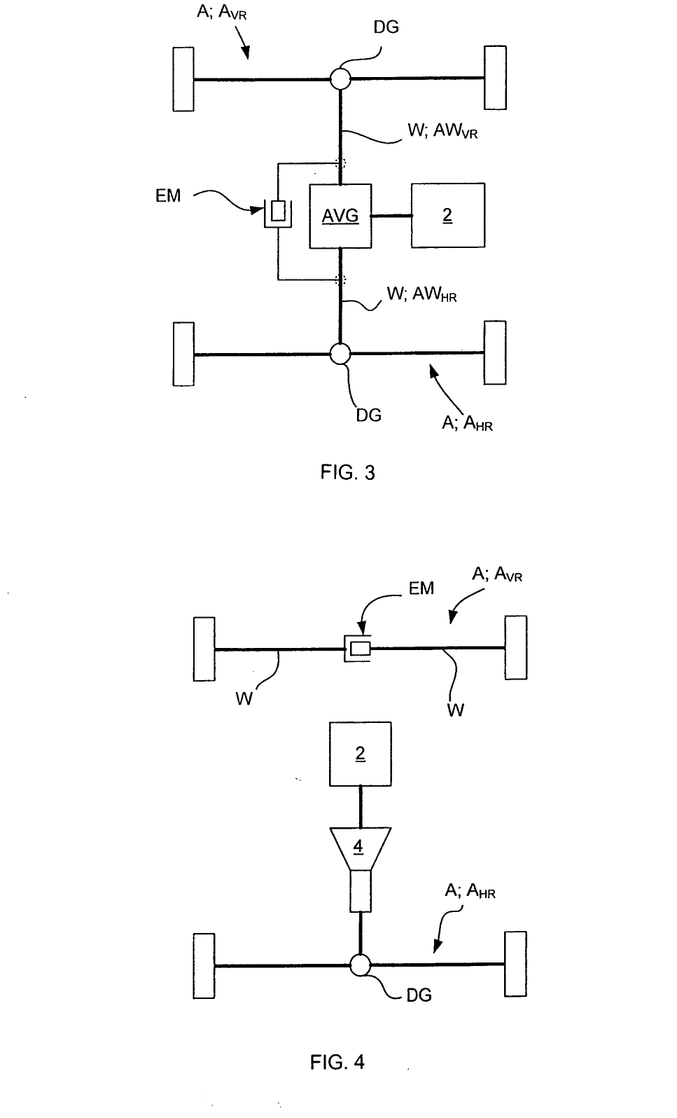

FIG. 3 shows an exemplary embodiment of the present invention in an all-wheel vehicle (all-wheel drive vehicle). In this case, the electrical machine EM is coupled on one hand to the driveshaft AW_{VR} (W) of an all-wheel transfer case AVG driving the front axle A_{VR} and on the other hand to the driveshaft AW_{HR} (W) of the all-wheel transfer case AVG driving the rear axle A_{HR}. In the present example, the rotor R of the electrical machine EM is coupled to the front driveshaft AW_{VR} and the stator S of the electrical machine EM is coupled to the rear driveshaft AW_{HR} (i.e., situated parallel to the all-wheel transfer case AVG driven via the internal combustion engine 2).

Another exemplary embodiment of the present invention is illustrated in FIG. 4. In this case, the electrical machine EM—without a gear connecting the two shafts (W) interposed—is integrated in a vehicle axle of a motor vehicle. A first drive part of the electrical machine EM (here: the stator S) is connected to the left vehicle axle part W and a second drive part of the electrical machine EM (here: the rotor R) is connected to the right vehicle axle part of a non-(directly) driven vehicle axle A, A_{VR} of a motor vehicle. In FIG. 4, the electrical machine is the direct (and single) connecting component of the two shafts W, in that the rotor R is situated directly on one shaft and the stator S is situated directly on the other shaft of a vehicle axle A_{VR}. A further difference from the embodiments in FIGS. 1 through 3 is that according to FIG. 4, the shafts and/or the axle parts W of a shared vehicle axle A are coupled via the electrical machine EM, and the shafts W are not driven directly, but rather indirectly by the transmission of the rolling movement of the motor vehicle over a roadway surface.

In all embodiments of the present invention, the control signals may be generated by the control unit SE as a function of vehicle operating parameters p1, . . . , pn for vehicle stabilization (for example, as in the DSC described at the beginning or the like) and/or for the chassis and suspension control system.

The power supply of the electrical machine EM may be performed using a separate power source, which is electrically connected via brush contacts to one of the rotating drive parts (stator S/rotor R).

The power supply is advantageously contactless, for example, by induction of a current, in that a magnetic field is generated via a fixed exciter coil, which generates a current in the secondary coil (e.g., stator coil) of the rotating system (electrical machine). In particular, the coils (primary coil and secondary coil) are situated in such a way that no torque feedback occurs on the rotating system due to the inductive power transmission. This is particularly achieved by the constructive configuration of primary coil and secondary coil to one another—e.g., by transmission of a fixed primary coil wound in the peripheral direction to a secondary coil of the rotating system which is situated axially offset or coaxially thereto. Alternatively, the decoupling may also be performed by decoupling in the frequency range. For this purpose, the fixed primary coil is clocked using one or more frequencies which do not contribute to torque production in the rotating system. This is achieved by a speed-dependent control or regulation.

A supplementary possibility for power supply of the rotating electrical machine includes situating an additional (also rotating) power source on one of the rotating machine parts (stator S or rotor R) themselves. The chronological power demand of the system according to the present invention is exploited for transverse torque distribution, because the system only briefly requires larger amounts of energy during a required torque distribution and this power demand by the configuration according to the present invention is also only very small in comparison to typical systems.

The possibly additionally provided power supply (in particular the inductive power transmission unit) may be dimensioned for small permanent outputs by the installation of an additional power accumulator on the rotating system itself, which is dimensioned sufficiently large to ensure the power supply in the event of single or multiple brief intervention (torque distribution).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A device for torque distribution between two rotatably mounted shafts, the device comprising:
a first rotatably mounted shaft;
a second rotatably mounted shaft;
an electrical machine including a rotor and a stator, the rotor being coupled support-free to one of the two shafts and the stator being coupled support-free to the other of the two shafts; and
a control unit coupled to the electrical machine for control signal transmission, the electrical machine being drivable as a function of control signals of control unit such that targeted transmission of torque is possible between the two shafts.

2. The device according to claim 1, wherein both rotatably mounted shafts are implemented as a component of a directly driven shaft of a motor vehicle and both shafts are connected to one another via a transmission unit.

3. The device according to claim 2, wherein both rotatably mounted shafts are implemented as a component of the driven vehicle axle and are connected to one another via a differential gear.

4. The device according to claim 2, wherein one of the rotatably mounted shafts is implemented as a transmission output shaft driven by a differential gear and the other rotatably mounted shaft is implemented as a component of a driven vehicle axle of a motor vehicle which is connected to the differential gear.

5. The device according to claim 2, wherein both rotatably mounted shafts are implemented as a component of a driveshaft connecting the front axle and the rear axle of an all-wheel-drive motor vehicle and are connected to one another via an all-wheel transfer case.

6. The device according to claim 1, wherein the rotatably mounted shafts are implemented as a component of a non-driven vehicle axle of a motor vehicle.

7. The device according to claim 1, wherein power is supplied to the electrical machine via a power storage unit, the electrical connection between the power storage unit and the electrical machine comprising brush contacts.

8. The device according to claim 1, wherein power is supplied to the electrical machine via an inductive power transmission unit.

9. The device according to claim 7, wherein power is supplied to the electrical machine via a power storage unit situated on at least one of the electrical machine, a stator portion thereof and a rotor portion thereof.

10. The device according to claim 2, wherein power is supplied to the electrical machine via a power storage unit, the electrical connection between the power storage unit and the electrical machine comprising brush contacts.

11. The device according to claim 3, wherein power is supplied to the electrical machine via a power storage unit, the electrical connection between the power storage unit and the electrical machine comprising brush contacts.

12. The device according to claim 4, wherein power is supplied to the electrical machine via a power storage unit, the electrical connection between the power storage unit and the electrical machine comprising brush contacts.

13. The device according to claim 5, wherein power is supplied to the electrical machine via a power storage unit, the electrical connection between the power storage unit and the electrical machine comprising brush contacts.

14. The device according to claim 6, wherein power is supplied to the electrical machine via a power storage unit, the electrical connection between the power storage unit and the electrical machine comprising brush contacts.

15. The device according to claim 2, wherein power is supplied to the electrical machine via an inductive power transmission unit.

16. The device according to claim 3, wherein power is supplied to the electrical machine via an inductive power transmission unit.

17. The device according to claim 4, wherein power is supplied to the electrical machine via an inductive power transmission unit.

18. The device according to claim 5, wherein power is supplied to the electrical machine via an inductive power transmission unit.

19. The device according to claim 6, wherein power is supplied to the electrical machine via an inductive power transmission unit.

20. A method for torque distribution between two rotatably mounted shafts, the method comprising the acts of:
coupling, support-free, a rotor of an electrical machine to one of the two shafts;
coupling, support-free, a stator of the electrical machine to the other of the two shafts;
coupling a control unit to the electrical machine for control signal transmission; and
driving the electrical machine as a function of control signals of the control unit to achieve targeted transmission of torque between the two shafts.
